(19) United States
(12) Patent Application Publication
(10) Pub. No.: US 2006/0099305 A1
(43) Pub. Date: May 11, 2006

(54) Bioproduction of hydrolysate from squid processing byproducts for aquaculture feed ingredient and organic fertilizer

(76) Inventors: Chong M. Lee, Wakefield, RI (US); Piezhi Lian, Sharon, MA (US)

Correspondence Address: Gauthier & Connors LLP, Suite 2300, 225 Franklin Street, Boston, MA, 02110, US

(21) Appl. No.: 11/259,174

(22) Filed: Oct. 26, 2005

Related U.S. Application Data
(63) Continuation of application No. PCT/US04/15671, filed on May 17, 2004.

(51) Int. Cl. A23L 1/31

(52) U.S. Cl. 426/55

(57) ABSTRACT

A bioproduction process of preparing an hydrolysate from squid processing byproducts. The process includes obtaining squid byproducts and hydrolyzing the byproducts. The hydrolyzed product are heated until the viscosity stabilizes. The hydrolyzed product is then filtered to form a filtrate and then concentrated to form the desired hydrolysate.

### PRIORITY INFORMATION

This application claims priority to U.S. Provisional Patent Application Nos. 60/470,651 and 60/547,963 filed on May 15, 2003 and Feb. 26, 2004, respectively, both of which are incorporated herein by reference in their entirety.

This invention was made with government support under Grant Number NA16FD2299 (NMFS); awarded by USDA/Department of Commerce—NMFS. The government has certain rights in the invention.—

### BACKGROUND OF THE INVENTION

The invention relates to the process for squid hydrolysate (SH) production, and in particular to the use of squid processing byproduct for production of hydrolysate, the use of SH for aquaculture feed ingredient, larval feed formulation and production from SH, the use of SH for larval feed production for all fin fish, at all ages, and all crustaceans, the use of SH for brood fish diet supplementation, the use of SH in plant protein-based marine fish diets for improvement of palatability and nutrition, and the use of SH for production of organic fertilizer.

Annually, approximately 6 million pounds of squid are processed in Rhode Island along with 5 million pounds in New Jersey. During a typical squid cleaning and dressing process in which mantles and tentacles are separated for food use, 40% end up as byproduct. The resulting byproduct largely consists of head, fin, wing, and viscera along with unclaimed mantles and tentacles. It contains approximately 11% protein, 2% lipid, 1.3% ash and 86% moisture. The level of protein is high enough for proteolytic hydrolysis (enzymatic digestion) to generate bioactive peptides and free amino acids. One of the unique features of this process is the use of endogenous enzymes for hydrolysis, eliminating the need to add commercial enzymes.

One of the viable approaches for seafood processing waste conversion is digestion or hydrolysis of the waste. The raw material that contains high level of protein can be broken into smaller and more bioavailable units, namely, peptides and free amino acids to which feeding animals respond differently compared to proteins. Hydrolysis reduces particle size and. provides uniformity, making the product more digestible. Because of this feature, hydrolysate could be conveniently formulated to a micro-diet to be used as starter and juvenile feeds. In addition, those released peptides and free amino acids could be potential chemo-attractants as well as feeding stimulants to carnivorous species. Digestion can be achieved by either enzymatic or acid hydrolysis. Most commercial hydrolysates are currently produced by acid hydrolysis of fish waste primarily for organic fertilizer and animal feeds. There are some organic fertilizers that are produced by an enzymatic process or aerobic fermentation. However, neither products nor reports on squid hydrolysate-based organic fertilizer could be located.

Enzymatic hydrolysis requires a short period of digestion with no undesirable byproducts, while acid hydrolysis takes longer for a complete digestion with potential formation of unwanted by-products. Acid hydrolysates are not as feed attractive as the enzymatic ones. It has been reported that acidified cod hydrolysates were less palatable than the fish meal diet when semi-moist diets were tested in Atlantic salmon. The feed attractant properties were not observed in finfish protein hydrolysate. The studies suggest that the feed attractant properties of hydrolysates highly depend upon the source or species from which the hydrolysate is prepared and how it is prepared. Squid has been found to possess properties of growth promotion, better digestibility, feed attractant and increased survival rate. It also possesses most of amino acids essential for the growth and survival of fish. All these findings support that squid hydrolysate can be an excellent source of aquafeed ingredient designed for starter and juvenile fish.

In one study, freeze-dried squid powder was fully hydrolysed with trypsin and pancreatin. Hydrolysate was not as effective as freeze-dried squid protein. A series of salmonid feeding studies demonstrated that partly hydrolysed fish protein outperformed fully hydrolysed ones. It was stressed that an optimum growth response requires a balanced mix of proteins, peptides and free amino acids. The difference between the previously-stated hydrolysate and the one described herein is that the one described herein is prepared from squid waste and visceral enzymes whereas the previous one was prepared from squid muscle meat with trypsin and pancreatin. The prior art hydrolysate was fully hydrolyzed, primarily free of amino acids, while the one described herein was partly hydrolyzed leaving a mix of protein, peptides and free amino acids. In addition, because of the differences in the raw material composition and the enzymes used, different properties of hydrolysate with different feeding response are expected between the two products. A patented process by Jeffrey et al. described in U.S. Pat. No. 4,405,649 is directed to a production of premium quality fish meal from whole fish with added proteolytic enzymes. Other studies completed with squid have been directed to the use of squid meal (dried and ground whole squid) in shrimp diets. Reportedly, squid meal is used as a protein source for many Penaeid species. Inclusion of 5-15% squid meal increased survival and weight gain. Its chemo-attractive attributes in stimulation of aquatic animal feeding response has also been reported. In addition, the squid protein fraction (SPF) has shown a growth-promoting effect in shrimp at levels from as low as 1.5% which was later related to an unknown “growth factor”, possibly low m.w. peptides. There have been little studies done on squid as an aquatic feed ingredient in relation to finfish feeding.

### SUMMARY OF TEE INVENTION

The bioproduction process of hydrolysate from squid processing byproducts for aquaculture feed ingredient and organic fertilizer include an environment friendly bioprocess with no chemical use. The process is enzymatic in nature and the material is hydrolyzed by its own (endogenous) enzymes making the process economical. The squid processing byproduct can be blended with fish meat (recovered from frame waste or underutilized fish species such as herring) for autolysis (hydrolysis with own enzymes). The raw material is a processing byproduct that is being presently paid to dispose of off site. Squid processing is a year-round activity and occurs primarily in Point Judith, R.I. The unique compositional characteristics make the squid hydrolysate a strong feed attractant and stimulant in aquaculture feeding. It has a good amino acid profile making it a growth promoter. The squid hydrolysate has feed attractability, and increases survival rate and feed conversion ratio. The increased survival rate suggests that hydrolysate may contain immune-enhancing medium molecular weight peptides and proteins.

An object of the present invention is to provide a fish feed ingredient wherein neither chemicals nor enzymes are added

A further object is to produce a fish feed ingredient from processing byproducts such that there is no cost for raw material.

Still another object of the invention is to provide a unique compositional characteristics that make squid hydrolysate attractive as feed ingredient as well as organic fertilizer.

### BRIEF DESCRIPTION OF THE DRAWINGS

These and other objects, features and advantages of the present invention will become apparent in light of the following detailed description of preferred embodiments thereof, as illustrated in the accompanying drawings.

FIG. 1 is a schematic for the production of squid hydrolysate; and

FIG. 2 is a schematic for the process variable in squid hydrolysate production.

### DETAILED DESCRIPTION OF THE INVENTION

With the growth of the fish farming industry, demands on fish feed ingredients are increasing of which fish meal takes up half or more depending on the age of animal, while the natural resource for fish meal production has reached its capacity. Suitable alternative feed ingredients have to be utilized to meet the growing aquaculture production. The aquaculture industry is looking for a new source of protein with unique properties such as feed attractant and stimulant for a starter diet, and a new generation starter diet that could fully or partially replace the expensive and hard-to-obtain live feeds. Turf grass, organic farming and home gardening industries are looking for a new generation organic fertilizer since each plant has its own growth requirements. Squid hydrolysate may have unique properties that the fish hydrolysate (currently in the market) does not have.

The production procedure includes processing byproducts collected from the waste stream and placing them into a homogenizer. Using submersible rotating blades; the fine slurry is pumped into a reaction vat and subjected to autolysis at 55° C. for 2 hr (established optimum hydrolysis temperature and time, see attached for test data) with constant stirring using a rotating scraper. The use of a scraper is needed to prevent fouling on the surface which reduces yield and heat transfer required for rapid, uniform heating. The progress of reaction is monitored by measuring viscosity changes. Based on the relationship of viscosity, changes to protein characterization, hydrolysis is terminated by heating to 75° C. for 30 min when the viscosity stabilizes or visually no protein coagulation occurs upon boiling. The resulting pasteurized hydrolysate is successively passed through vibrating screens of 100 and 325 standard U.S. meshes. The filtrate is concentrated in a vacuum evaporation system with a falling film of forced circulation at 48° C. and 28 in Hg vacuum until the concentration of hydrolysate increases from 14% to 35% solids. The concentrate is trucked for immediate use, filled into plastic containers for frozen storage, or shelf-stabilized with phosphoric acid (1.75% usage level). For powder products, hydrolysate concentrate can be blended with fish meal or oilseed meal at an appropriate proportion and low-heat dried at around 45° C. The squid hydrolysate in concentrate or powder form can be used as an aquaculture feed ingredient in either partial or total replacement of fish meal.

Squid hydrolysate produced at 2 hr-hydrolysis showed stronger attractability (21 out of 25 fish) than the control (2.5/25), 0 hr-hydrolysate (10.5/25) and 3 hr-hydrolysate (10/25) when tried on trout fingerlings. This may be attributed to increases in attractant free amino acids, gly, ala, and val by 275, 210, and 285%, respectively. In Atlantic salmon juvenile feeding, diets were prepared with fish meal replacement at 0, 5 and 10% on a protein weight basis. A higher survival rate (77.5% over 65% control) of the diet with 10%-squid hydrolysate replacement, and a higher feed efficiency ratio (1.62±0.11 over 1.34±0.02 control) with 5% replacement were observed. The effect of squid hydrolysate as an attractant and growth stimulation on Atlantic salmon starters was studied using a commercial salmon starter diet spray-coated with 5% and 10% (on a diet weight basis) of liquid squid hydrolysate and oil mixture (8:2) in the form of emulsion. Upon 7-week feeding of salmon sacfries (50 fish per 110 gel aquarium), the food conversion ratio (FCR) and daily weight increase ratio (DWR) of the diet coated with 5% of squid hydrolysate were 0.96 and 2.81, respectively, compared to control (1.12 and 2.56). Additional fish species to be tested with squid hydrolysate included summer flounder and Atlantic cod. Blending 7 parts squid byproduct and 3 parts fish meat resulted in adequate hydrolysis where squid is served as a source of proteolytic enzymes. This means that a fish-squid hydrolysate blend can be produced as needed.

Improved growth and survival rate are expected from feeding trials on starter fish of all species, including Atlantic salmon, summer flounder, and Atlantic cod. However, there may be variations in feeding responses among species, in the event when a particular species stands out in feeding response, further diet refining and marketing efforts can be directed to that species. In light of a large output of finfish processing byproducts after filleting operation and the availability of underutilized pelagic species such as herring, concurrent efforts may be given to hydrolysis of fish with squid as a source of enzymes and attractant and stimulant. A preliminary study indicated 3 parts of fish meat (recovered by deboning machine) and 7 parts of squid byproducts showed adequate hydrolysis.

In order to determine optimum hydrolysis conditions for the production of desirable squid hydrolysate, a lab-scale reaction vessel for squid hydrolysis was constructed with a stainless-steel reaction chamber (15 gal) housed in a retort vessel which provided a heating medium. The temperature of the reaction medium (squid homogenate) was regulated by hot water whose temperature was controlled by steam injection. The filtered hydrolysate (87% moisture) was concentrated using a concentrator to 71% or lower depending upon the solid content requirement for feed formulation. In addition, a hot-water jacketed cooker (40 gal) was used as a batch concentrator. Both retort vessel and concentrator utilized a temperature-controlled hot water circulation system. A steam injection regulator was also installed to control the temperature of the heating medium.

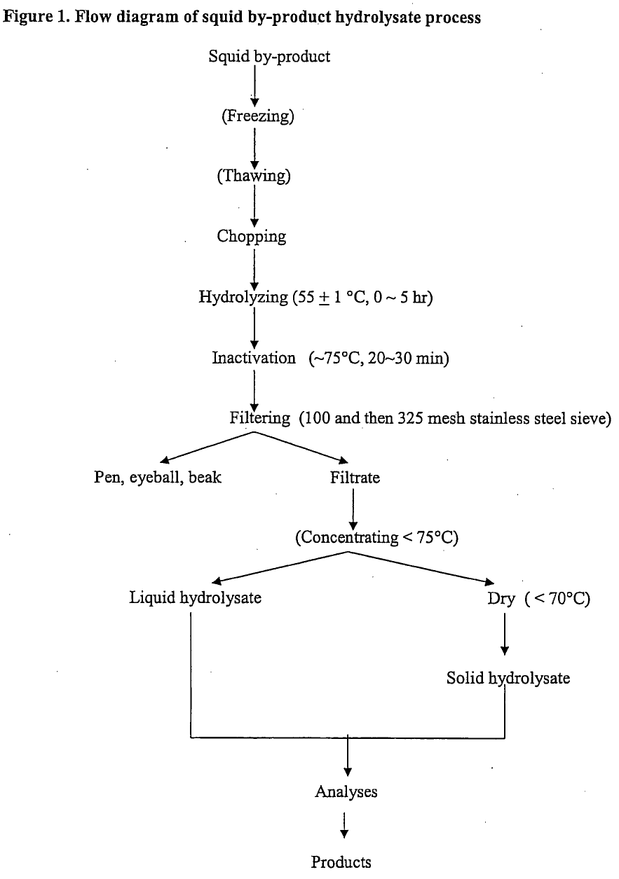

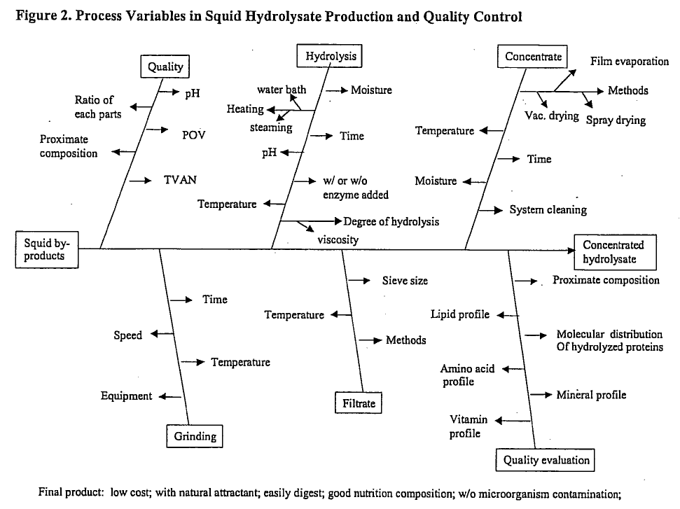

The schematic procedures for the production of hydrolysate and concentrate, and process variables for hydrolysate production and quality control are given in FIGS. 1 and 2, respectively.

Squid (Loligo pealei) by-product consisting of heads, viscera, skin, fins, and small tubes were grounded before hydrolysis. Hydrolysis was carried out for 0, 0.5, 1, 1.5, 2, 3, 4 and 5 h at 55° C. and analyzed for changes in the degree of hydrolysis (DH), viscosity, protein and peptide profiles, amino acid profile, and proximate composition.

The moisture, lipid, ash and protein contents in the raw squid processing waste were approximately 85.3-86.7%, 1.8-2.3%, 1.2-1.4% and 10.15-10.75%, respectively. From the free amino acid profiles of hydrolysate (Table 1), all individual amino acids increased at different levels during hydrolysis. As attractants of amino acids, like glycine, alanine and valine, increased significantly (236.07%, 172.89% and 228.56%) during 2 h hydrolysis.

TABLE 1
Changes in TCA-soluble amino acid profile (mg/g hydrolysate)
of squid by-product during autolysis

| Amino | Hydrolysis time (min) | | | | | | | |
|---|---|---|---|---|---|---|---|---|
| acids | 0 | 30 | 60 | 90 | 120 | 150 | 180 | % Change |
| Asp | 1.17 | 2.77 | 2.75 | 3.55 | 3.83 | 4.02 | 4.71 | 301.95 |
| Glu | 1.79 | 4.57 | 4.86 | 5.68 | 6.14 | 6.48 | 7.07 | 296.02 |
| Ser | 0.54 | 1.01 | 1.03 | 1.14 | 1.29 | 1.35 | 1.49 | 175.41 |
| Gly | 0.75 | 1.67 | 2.06 | 2.22 | 2.52 | 2.61 | 2.82 | 275.44 |
| His* | 0.28 | 0.51 | 0.53 | 0.55 | 0.61 | 0.63 | 0.67 | 137.74 |
| Arg* | 6.26 | 7.21 | 7.07 | 7.39 | 7.84 | 8.48 | 8.63 | 37.89 |
| Thr* | 0.64 | 1.36 | 1.79 | 1.92 | 2.19 | 2.33 | 2.54 | 297.73 |
| Ala | 0.88 | 1.86 | 1.92 | 2.16 | 2.40 | 2.48 | 2.73 | 210.01 |
| Pro | 1.40 | 2.21 | 2.57 | 2.60 | 2.88 | 3.03 | 3.01 | 114.66 |
| Tyr | 0.68 | 0.81 | 0.99 | 1.11 | 1.27 | 1.31 | 1.47 | 114.86 |
| Val* | 0.45 | 1.08 | 1.13 | 1.29 | 1.48 | 1.50 | 1.73 | 284.84 |
| Met* | 0.04 | 0.13 | 0.17 | 0.21 | 0.22 | 0.21 | 0.23 | 456.51 |
| Cys2 | — | 0.01 | 0.02 | 0.00 | 0.01 | 0.01 | 0.00 | — |
| Ile* | 0.34 | 0.91 | 1.01 | 1.04 | 1.23 | 1.21 | 1.45 | 326.03 |
| Leu* | 0.47 | 1.80 | 1.93 | 2.14 | 2.43 | 2.41 | 3.04 | 541.15 |
| Phe* | 0.41 | 0.80 | 1.44 | 1.45 | 1.79 | 1.79 | 2.11 | 420.43 |
| Lys* | 0.88 | 1.64 | 1.94 | 1.66 | 1.95 | 2.41 | 2.84 | 222.94 |
| Total FAA | 16.99 | 30.36 | 33.19 | 36.11 | 40.08 | 42.26 | 46.55 | |
| (mg/g)¹ | | | | | | | | |
| Fold² | 1.00 | 1.79 | 1.95 | 2.13 | 2.36 | 2.49 | 2.74 | |
| EAA | 9.77 | 15.45 | 17.00 | 17.65 | 19.74 | 20.97 | 23.25 | |
| (mg/g)³ | | | | | | | | |
| Fold⁴ | 1.00 | 1.58 | 1.74 | 1.81 | 2.02 | 2.15 | 2.38 | |

¹total free amino acid contents.
²increase of total free amino acids at certain time of hydrolysate divided by the free amino acid contents at 0 min
³essential amino acids for fish feed
⁴increase of essential amino acids at certain time of hydrolysis divided by the essential amino acid content at 0 min

The DH value markedly increased from 10.17±0.27 to 18.7±0.92 upon 2 h hydrolysis, where the initial high DH value reflects the rapid initiation of hydrolysis upon mechanical homogenization prior to the heat-assisted reaction. Viscosity of the hydrolysate exponentially decreased. No further marked changes in DH and viscosity were observed after 2 h hydrolysis. A hydrolysis of 2 h with a DH value of around 18.7 yielded peptides as the major fraction with a small fraction of partially hydrolyzed proteins which is believed to be a contributing factor to an optimum nutrition for fish growth. The change in viscosity can be used to monitor the progression of hydrolysis up to the molecular weights larger than 26.63 kDa disappearance.

Squid hydrolysate can be used as a feed attractant. Squid hydrolysates as feed attractant were tested in two 72 L-aquarium (60 cm L×30 cm W×40 cm H) using 25 trout fingerlings (Oncorhychus mykiss) in each aquarium. Hydrolysate and control (distilled water) (10 g each) were injected into the respective cotton ball, and put into hollow plastic golf balls with 20 5-mm-openings, which were placed into the respective aquarium and allowed for the release of attractants. The size of the affected area was a spherical region with a 5-cm radius around the cotton ball. After 2 min, the fish appeared in this area were counted in the next 5 min. Results showed that the attractability of squid hydrolysate with 2 h hydrolysis was markedly stronger (21 out of 25 fish) than control (2.5/25), 0 hr-hydrolysate (10.5/25) and 3 hr-hydrolysate (10/25) (Table 2). This demonstrates that squid hydrolysate does act as a strong attractant with proper hydrolysis. Over-hydrolysis reduced the attracting properties of hydrolysate due to the formation of unidentified small molecules.

TABLE 2
Effect of hydrolysis time on squid
hydrolysate attracting properties

Fish number observed* in 5 min

| Hydrolysis time (min) | Sample | Control |
|---|---|---|
| 0 | 10.5 ± 3.5 | 2.5 ± 0.7 |
| 120 | 21.0 ± 4.2 | 2.5 ± 0.7 |
| 180 | 10.0 ± 2.8 | 3.0 ± 1.4 |

Note:
Data was mean of duplicate test
*appeared in 5-cm radius around the ball.

Feeding studies were conducted on Atlantic salmon juvenile and starter fish. In Atlantic salmon juvenile feeding, diets were prepared with fish meal replacement at 0, 5 and 10% on a protein weight basis. A higher survival rate (77.5% over 65% control) of the diet with 10%-squid hydrolysate replacement, and a higher feed efficiency ratio (1.62±0.11 over 1.34±0.02 control) with 5% replacement were observed (Table 3). The effect of squid hydrolysate as an attractant and growth stimulation on Atlantic salmon starters was studied using a commercial salmon starter diet spray-coated with 5% and 10% (on a diet weight basis) of liquid squid hydrolysate and oil mixture (8:2) in the form of emulsion (Table 4). Upon 7-week feeding salmon sacfries (50 fish per 110 gal aquarium), the food conversion ratio (FCR) and daily weight increase ratio (DWR) of the diet coated with 5% of squid hydrolysate were 0.96 and 2.81, respectively, compared to control (1.12 and 2.56).

TABLE 3
Feeding trial of Altantic juvenile salmon (16 weeks)

| | FER | | PER | | Survival rate | | DLG(mm/day) | | SGR (% day) | |
|---|---|---|---|---|---|---|---|---|---|---|
| Diets | AVE | SD | AVE | SD | Ave | SD | AVE | SD | AVE | SD |
| Control | 1.34 | 0.02 | 2.79 | 0.01 | 65 | 7.07 | 0.94 | 0.05 | 1.81 | 0.10 |
| 5% SH | 1.62 | 0.11 | 3.42 | 0.23 | 65 | — | 0.77 | 0.12 | 1.51 | 0.37 |
| 10% SH | 1.21 | 0.04 | 2.56 | 0.08 | 77.5 | 17.68 | 0.74 | 0.13 | 1.23 | 0.13 |

FER: feed efficiency ratio;
PER: protein efficiency ratio;
DLG: daily length growth;
SGR:specific growth rate (%): [(In WT/Wt)/T − t] × 100 where WT and Wt: body weight at the end and the beginning of feeding

TABLE 4
Feeding study on Atlantic salmon sacfries with starter diet coated with squid hydrolysate emulsion

| | Length (cm) | | | Weight (g) | | | | | |
|---|---|---|---|---|---|---|---|---|---|
| | Time (days) | | | | | | | | Survival |
| Sample | 0 | 21 | 42 | 0 | 21 | 42 | FCR | SGR | ratio (%) |
| Control | 5.00 ± 0.37 | 6.00 ± 0.47 | 7.00 ± 0.50 | 1.43 ± 0.34 | 2.69 ± 0.64 | 4.14 ± 0.90 | 1.12 | 2.37 | 72 |
| 5% SH | 5.00 ± 0.37 | 5.10 ± 0.56 | 7.20 ± 0.71 | 1.43 ± 0.34 | 2.92 ± 0.86 | 4.56 ± 1.24 | 0.96 | 2.61 | 94 |
| 10% SH | 5.00 ± 0.37 | 5.90 ± 0.49 | 7.00 ± 0.58 | 1.43 ± 0.34 | 2.62 ± 0.62 | 4.32 ± 1.13 | 1.06 | 2.67 | 96 |

FCR: feed conversion ratio (dried feed g/weight gain g);
SGR: specific growth rate

A feeding trial of squid hydrolysate microdiet on cod larvae was conducted. A squid hydrolysate microdiet can be useful in cod larvae. To examine this the following was completed. Approximately 0.25 million of cod larvae were placed in each production tank (5 m³). One tank was set up for squid hydrolysate(SH)-larval diet along with six tanks (Control group) for the standard commercial diet (Gemma Micro 300, by Skretting). Upon hatch, cod larvae were on rotifer for 20 days, followed by 10 days on the combined feeding of rotifer and Artemia. This was followed by co-feeding of Artemia and microdiet which is simply a strategy to introduce an inert feed to the fish. Weaning actually began about 1 week later as Artemia was gradually removed from the feeding schedule. Following the weaning period, the fish were kept on the SH microdiet for another 2 weeks. Upon introduction of SH diet, fish seemed to jump onto the diet without hesitation clearly indicating that the diet had strong attractive properties. This is particularly important since cod is found to be very finicky, more difficult to wean than black sea bass and flounder.

Weaning is the most crucial aspect of production, and thus a high survival is always desired in the successful hatchery business. 70-75% of the fish on the SH microdiet survived through the weaning period, which is considered excellent. The control group was also in the 70-75% range as well. Overall, there was no real difference in survival among the production tanks during weaning. Most commercial microdiets fall way short of 70-75%. The standard diet used for the control group is currently regarded as the best in the industry and most expensive.

As for tank hygiene, the SH diet was rated better than the standard. The SH diet appeared to stay very stable in the water without leaching. Leaching tends to cause foam on the surface (which is a problem with the standard diet).

There appeared to be a difference in behavior between the fish fed SH diet and the rest. The SH fish had a lighter color. A darker color is often associated with stress. The SH fish were very responsive as a sign of good health. The fish appeared to be more uniform in size indicating that the fish weaned onto the diet in a uniform manner. This has very significant ramifications as it relates to cannibalism and grading. Along the same lines, the fish were swimming together in uniform manner. They appeared to be in motion more so than the other tanks.

Total lengths of larvae were measured every week as a measure of growth. Results are given in Table 5 where EL3 represents the SH diet group and the SH diet was introduced at 30 days post hatch (dph) at the end of live diet feeding. The feeding lasted for 2 weeks. Measurements done while fish were on the SH diet were at sampling periods 35-38 and 42-45 dph.

TABLE 5
Total length of cod larvae at various sampling periods

| Sampling | | | | | | | |
|---|---|---|---|---|---|---|---|
| Period | EL 1 | EL 2 | EL 3 | EL 4 | EL 5 | EL 6 | EL 7 |
| 14-17 DPH | 7.2 +/− 0.10 | 7.3 +/− 0.06 | 8.1 +/− 0.09 | 7.4 +/− 0.14 | 7.7 +/− 0.12 | 8.0 +/− 0.05 | 8.2 +/− 0.13 |
| 19-21 DPH | 8.6 +/− 0.13 | 8.5 +/− 0.11 | 8.7 +/− 0.09 | 8.4 +/− 0.21 | 8.8 +/− 0.13 | 8.8 +/− 0.07 | 8.3 +/− 0.13 |
| 28-29 DPH | 10.1 +/− 0.12 | 10.8 +/− 0.17 | 11.3 +/− 0.15 | 10.2 +/− 0.28 | 11.0 +/− 0.17 | 10.5 +/− 0.12 | 10.5 +/− 0.15 |
| 35-38 DPH | 11.6 +/− 0.32 | 14.6 +/− 0.46 | 14.9 +/− 0.26 | 13.8 +/− 0.34 | 13.6 +/− 0.36 | 13.3 +/− 0.16 | 14.4 +/− 0.33 |
| 42-45 DPH | 15.9 +/− 0.37 | 16.3 +/− 0.54 | 18.3 +/− 0.41 | 16.8 +/− 0.72 | 16.6 +/− 0.56 | 16.7 +/− 0.38 | 17.5 +/− 0.65 |
| 49-50 DPH | 18.8 +/− 0.5 | | | | 21.2 +/− 0.5 | 20.1 +/− 0.4 | 21.4 +/− 0.7 |

The stress test was conducted by exposing larvae to a salinity of 65 ppt (6.5%) for 60 min. The number of dead larvae were counted in the container every 3 min. At the end of 60 min, the cumulative mortality was used as a Cumulative Stress Index (CSI-60). The lower the number, the better “condition” the larvae are, or specifically, the more resistance the larvae is to salinity shock. It is a common test used throughout the bass and bream industry in Europe to evaluate larvae sourced from different hatcheries. It is also often used in R&D to evaluate fish condition from various treatments. The SH diet group showed more resistant to salinity shock, and was thus in better condition than the control group on the standard commercial diet. The bioproduction of hydrolysate from squid processing byproducts may be used for aquaculture feed ingredient and organic fertilizer. Bioproduction of hydrolysate from squid processing byproducts may also be used for aquaculture feed ingredient and because of the levels of N, K and P, which are also key nutrients for plant growth, squid hydrolysate can be used as organic fertilizer. The product can be shelf-stabilized at a pH of 3.5 with phosphoric acid and marketed as an organic fertilizer.

Larval feed may be formulated and produced for feeding summer flounder. Squid hydrolysate (SH) or squid-fish mince hydrolysate (SFH) is used as a sole source of protein with addition of various ingredients for example, fish oil with adequate level and ratio of EPA and DHA, algae, yeast, mineral and vitamin premix. Salmon oil may be used as a source of fish oil. Squid hydrolysate (86% moisture; 11% protein; 2% oil) contains 11.16% EPA and 24.45% DHA (on an oil weight basis), while salmon oil contains 8.65% EPA and 10.67% DHA. The composition of basal squid hydrolysate-based microdiet is given in Table 6. The 100 g basal squid hydrolysate diet provides 2.00 g EPA and 3.60 g DHA based on EPA/DHA distribution. A high DHA/EPA ratio is known to be desirable for the survival and growth of most marine larval fish. The squid to fish mince ratio=7:3; and SH or SFH is a concentrated one (74% moisture) from the original stock (86%)

TABLE 6
Composition of squid hydrolysate-based basal microdiet

| | (% dry | | | | Mineral | |
|---|---|---|---|---|---|---|
| Ingredients | weight basis) | Vitamin premix | IU/Kg | mg/Kg | premix | g/kg |
| Squid hydrolysate | 73.33 | Vit-A acetate | 6000.0 | | AlCl₃.6H₂O | 0.003 |
| Salmon oil | 9.54 | Vit-D3 cholecalciferol | 1000.0 | | CaHPO₄ | 9.690 |
| Lecithin | 3.01 | Vit-E tocopherol acetate | 125.0 | | CuSO₄.5H₂O | 0.010 |
| Vit-premix | 0.44 | Menadione Vit-K | | 16.50 | CoCl₂.6H₂O | 0.020 |
| Mineral premix | 2.01 | Thiamine mononitrate | | 10.00 | FeSO₄.7H₂O | 0.100 |
| Starch | 5.02 | Riboflavin | | 25.20 | NaH₂PO₄.H₂O | 1.760 |
| Yeast | 4.02 | Niacin | | 150.00 | KI | 0.003 |
| Algae | 2.64 | Ca-pantotenate | | 55.00 | MgSO₄.7H₂O | 2.640 |
| (spirulina:chlorella) | | Pyridoxine | | 15.00 | MnSO₄.H₂O | 0.028 |
| Protein | 64.66 | Folic acid | | 4.00 | NaCl | 0.826 |
| Lipid | 18.72 | B12 | | 0.02 | Na₂SeO₄ | 0.001 |
| Carbohydrate | 7.40 | Biotin | | 1.00 | K₂HPO₄.3H₂O | 4.800 |
| Ash | 9.21 | Inositol | | 600.00 | ZnSO₄.7H₂O | 0.120 |
| Energy (MJ/Kg) | 19.12 | Ascorbate | | 400.00 | | |
| | | Choline chloride | | 1500.00 | | |

Once the diet was formulated to meet the nutrient requirements of larval fish including nutrient supplementation if needed, the diet mix was homogenized in a sequential manner (mix SH and water-soluble ingredients; lecithin, oil-soluble ingredients and one half the oil; homogenize the mix with the remaining half the oil) in a vacuum mixer, and the resulting mix is subjected to the emulsification in a two-stage homogenizer for microencapsulation to provide chemical stabilization and physical integrity for control of lipid oxidation and leaching of water-soluble nutrients, respectively. The emulsified slurry was drum dried at a moderate temperature not to cause thermal degradation. The dried product was micronized using a mill to produce microparticles of desired sizes.

A feeding trial was conducted using two experimental diets, a live feed (Artemia), and a commercial starter feed (Proton 2 and 3, Inve Aquaculture, Grantsville, Utah). Summer flounder larvae were obtained from Great Bay Hatchery in NH which were hatched 2-weeks prior. Larvae were randomly arranged into 13 aquaria (21 L, 48 larvae each) filled with 11.5 L seawater at 18.5±1.5° C., pH 7.8˜8.0, salinity 28˜30 g L⁻¹ in triplicate except for the control (no food given). Feeding was carried out manually five times daily to satiation. The daily dose of diet given was 20% of the total fish weight. The results of 22-day feeding showed that stomach color of fish larvae fed with squid hydrolysate-based diets were gradually changed from orange to slight brown during the first three-day feeding trial. This indicated that fish larvae accepted the squid hydrolysate-based diet immediately after consuming the existing Artemia in their stomach. The survival rate (91.67±2.95%) and SGR (2.23) of larvae fed with squid hydrolysate were significantly (p<0.05) higher than others except that its SGR insignificantly differed from that of Artemia (2.86) (Table 7). The commercial diet showed least survival (65.28±4.34%) and SGR (1.39).

TABLE 7
Survival, wet weight, length and specific growth
rate of summer flounder larvae after 22-day feeding
trial (October 1-23) (2 wk old larvae)

| | Survival | Weight (mg) | | Length (mm) | | |
|---|---|---|---|---|---|---|
| Diets | rate (%) | Initial | 22 days | Initial | 22 days | SGR |
| Artemia | 81.25^{a} | 15.78 | 32.22^{a} | 8.56 | 12.24^{a} | 2.86^{a} |
| Commercial | 65.28^{b} | 15.78 | 21.65^{b} | 8.56 | 11.06^{b} | 1.39^{b} |
| Squid only | 91.67^{c} | 15.78 | 26.36^{ab} | 8.56 | 11.67^{ab} | 2.23^{ab} |

*45 larvae in each 3.5 gal (13 L aquarium), fed 5 times a day.
^{a-c}Means in the same column with different superscripts are significantly different (p < 0.05; n = 2)

Application of SH-based larval diets may be given to other marine fish and fresh water and marine crustacean species for survival and growth. The Application of SH to brood fish for nutrition enhancement may be accomplished as well. For better survival and growth, the brood (egg laying) fish requires good nutrition to lay quality eggs from which healthy larvae are hatched. The supplementation with SH is intended to improve palatability and the overall nutritional quality of the diet. There is also an application of SH to plant protein-based aquaculture feed. With rising concerns with PCB and mercury contaminations along with anticipated shortage of fish meal and oil supplies, much effort has been given to fish meal replacement with plant proteins. SH can be added to overcome inherent palatability and digestibility problems associated with plant proteins. A feeding study with summer flounder is being planned.

Although the present invention has been shown and described with respect to several preferred embodiments thereof, various changes, omissions and additions to the form and detail thereof, may be made therein, without departing from the spirit and scope of the invention.

What is claimed is:

1. A bioproduction process of preparing an hydrolysate from squid processing byproducts, said process including:
obtaining squid byproducts;
hydrolyzing the byproducts;
heating the hydrolyzed product until the viscosity stabilizes;
filtering the heating product to form a filtrate;
concentrating the filtrate to form the desired hydrolysate.

2. The bioproduction process of claim 1, wherein the byproducts are hydrolyzed for between 0 and 5 hours.

3. The bioproduction process of claim 1, wherein the byproducts are hydrolyzed at temperature of about 50-60° C.

4. The bioproduction process of claim 1, wherein the filtrate is concentrated in a vacuum evaporation system.

5. The bioproduction process of claim 1, wherein the filtrate is concentrated until the solids are increased from about 10-15% to about 30-40%.

6. The bioproduction process of claim 5, wherein the filtrate is concentrated until the solids are increased from about 14% to about 35%.

7. The squid processing byproduct of claim 1 is blended with fish meat for autolysis.

8. The squid processing byproduct of claim 7 wherein the fish meat is recovered from frame waste or underutilized fish species such as herring.

9. The squid hydrolysate of claim 1, wherein the hydrolysate is increases feed attractability and survival rate as a fish feed ingredient.

10. The squid hydrolysate of claim 1, wherein the hydrolysate is a growth promoter in fish feed.

11. The squid hydrolysate of claim 1, wherein the hydrolysate is a strong feed attractant and stimulant in aquaculture feed.

12. The squid hydrolysate of claim 1, wherein the hydrolysate may be used as an aquaculture feed ingredient or organic fertilizer turf grass, organic farming and home gardening.

13. The squid hydrolysate of claim 1, wherein the includes phosphoric acid to prepare a shelf-stabilized product.

14. A fish feed ingredient prepared by hydrolyzing squid byproducts to form a hydrolysate.

15. The hydrolysate of claim 14, wherein the hydrolysate is an aquaculture feed ingredient, a larval feed formulation for all fin fish at all ages and for all crustaceans, a diet supplement for brood fish, as a fish feed supplement to improve palatability and nutrition and as an organic fertilizer.
